(19) United States
(12) Patent Application Publication
(10) Pub. No.: US 2008/0090211 A1
(43) Pub. Date: Apr. 17, 2008

(54) Implant For Dental Prosthesis, And Method And System For Producing The Implant

(75) Inventor: Matts Andersson, Lerum (SE)

Correspondence Address: KNOBBE MARTENS OLSON & BEAR LLP, 2040 MAIN STREET, FOURTEENTH FLOOR, IRVINE, CA, 92614, US

(73) Assignee: NOBEL BIOCARE SERVICES AG, ZURICH-FLUGHFEN (CH)

(21) Appl. No.: 11/574,573

(22) PCT Filed: Aug. 11, 2005
(86) PCT No.: PCT/SE05/01201

§ 371 Date: Aug. 27, 2007

(30) Foreign Application Priority Data
Sep. 1, 2004 (SE) 04 02108-5

(51) Int. Cl. A61C 13/00

(52) U.S. Cl. 433/201.1

(57) ABSTRACT

An implant is provided that can be implanted into a hole of a jaw bone. The implant comprises inner and outer parts. The inner part is sized and configured to be inserted into the hole of the jaw bone. The outer part is sized and configured to support a dental prosthesis. The inner part at least partially comprises compressed biocompatible metal powder. The outer part at least partially comprises compressed biocompatible ceramic powder. The compressed biocompatible ceramic and metal powders of the respective ones of the inner and outer parts can be collectively compressed to form the body of the implant. Further, a method and system for producing the implant are also provided. The implant can eliminate the need to conceal dark coloring caused by the metal powder where the implant emerges from the hole in the jaw bone.

### CROSS-REFERENCE TO RELATED APPLICATIONS

This application is a U.S. National Phase of International Application No. PCT/SE2005/001201, International Publication No. WO 2006/025777, filed Aug. 11, 2005, which claims priority to Swedish Patent Application No. 0402108-5, filed Sep. 1, 2004, each of which is hereby incorporated by reference in its entirety.

### BACKGROUND

1. Field of the Inventions

The present inventions relate generally to dental implants, and more specifically to a dental implant having a uniquely configured body shape that is implantable into a jaw bone by means of an inner part and being operative to support a dental prosthesis by means of an outer part. The inventions also relate to a method and a system for producing such an implant.

2. Description of the Related Art

It is known in the art that implants and other prosthetic constructions can be produced from compressed (i.e. sinterable) metal powder. In many instances, the implants and other prosthetic constructions have preferably been made of titanium powder, and if appropriate, in the form of an alloy. For example, see PCT International Patent Publication No. WO 00/15137, entitled “METHOD AND DEVICE FOR, AND USE OF, A DENTAL PRODUCT OR OTHER PRODUCT FOR THE HUMAN BODY,” and PCT International Patent Publication No. WO 03/061509, entitled “ARRANGEMENT, DEVICE, METHOD, PRODUCT AND USE IN CONNECTION WITH A BLANK MADE PREFERABLY OF TITANIUM POWDER,” the entireties of both of which are incorporated herein by reference.

It is also already known in the art that crowns and other prosthetic parts can be produced from compressed (i.e. sinterable) ceramic powder. For example, see PCT International Patent Publication No. WO 97/01408, entitled “METHOD AND MEANS FOR PRODUCING A CERAMIC OR METALLIC PRODUCT FOR SINTERING,” the entirety of which is incorporated herein by reference.

Further, it is also already known in the art to provide fully automatic production systems for the production of dental products. For example, see European Patent Application Publication No. EP 490848, entitled “A PROCEDURE AND APPARATUS FOR PRODUCING INDIVIDUALLY DESIGNED, THREE-DIMENSIONAL BODIES USABLE AS TOOTH REPLACEMENTS, PROSTHESES, ETC., and European Patent Application Publication No. EP 634150, entitled “PROCESS AND DEVICE IN CONNECTION WITH THE PRODUCTION OF A TOOTH, BRIDGE, ETC.,” the entireties of both of which are incorporated herein by reference.

### SUMMARY

Implants made of titanium or alloyed titanium now represent a well proven and satisfactory product which has great biocompatibility with the human body. Therefore, these products can constitute a very advantageous basis, from the medical point of view, for a prosthetic fixture.

However, titanium or alloyed titanium both have a serious disadvantage in that they have a relatively dark color, which may be visually undesirable. In particular, the portion of the implant, which is situated at an upper part of the hole in which the implant is fitted and near the gum, is difficult to conceal. The dark color can show through and prevent a completely satisfactory result from an aesthetic point of view. Various embodiments disclosed herein are directed to solving these and other problems.

According to an aspect of at least one of the embodiments disclosed herein is the realization that it is important that a biocompatible and effective material can be retained in all parts of the implant, and that well proven application and production methods can be used without the need for substantial changes that greatly increase costs. Embodiments disclosed herein are directed at solving this problem as well.

According to an embodiment of the implant, an inner part of the implant can be made completely or partially of compressed (i.e. sintered) powder of biocompatible metal, and is preferably made at least partially of titanium or alloyed titanium. Further, an outer part of the implant can be made completely or partially of compressed powder of biocompatible ceramic, is preferably made at least partially of zirconium dioxide. The metal and/or ceramic powders can be compressed or pressed together to form a body shape of the implant in a single piece.

In a preferred embodiment, the inner part can be fitted in a hole in the jaw bone. In this regard, the inner part can be sized and configured to be able to cooperate substantially with the jaw bone. Additionally, the outer part can extend through an upper part of the hole and through the gum and out into the oral cavity. In some embodiments, the compressed ceramic powder can be pressed together with the compressed metal powder, and can have a light color or shade or can be substantially white. The metal powder can comprise alloyed titanium of grade four, and it can comprise approximately 6% aluminum and approximately 4% vanadium.

In some embodiments, particle size or grain size can be selected according to user needs. The implant can be made up of a plurality of parts, such as two or more, which can be arranged in different or layered powder types with or without specific transition layers between respective part pairs. The term “layered” is intended to signify layers which are of the same type of material, but which are not located next to one another, and are instead separated by another powder type. Some of the features of certain embodiments are set forth in the dependent claims relating back to the main implant claim.

According to another embodiment, a method is provided for production of the implant. In some embodiments, the method comprises utilizing metal powder for complete or partial formation of the inner part and ceramic powder for complete or partial formation of the outer part. These powders can be applied, compressed and pressed together under vacuum, and preferably in a pressing tool, for formation of the body shape. The compression and pressing together can take place in a single step.

In a preferred embodiment, the metal powder used can be an alloyed titanium powder and the ceramic powder used can be zirconium dioxide. The particle and/or grain sizes can be chosen to optimize the strength of the compressed or sintered powder types. The pressing together of the powders can yield very high temperatures, such as approximately 1100° C. Therefore, the tool and its components should be made of appropriate materials, such as graphite, for such an application. The pressing tool can be designed with one or more mold cavities having smooth mold cavity walls.

In accordance with yet another embodiment, a system is provided for producing the implant. The system can include identification members for determining the inner and outer parts' shapes and relationships to one another. Further, depending on the powder types and particle and/or grain sizes required, the members of the system can determine the powder quantities for the inner and outer parts, as well as determine whether a possible transition layer is needed between the parts, and if so, what its parameters should be. In some embodiments, the application members can apply the metal and ceramic powders in a pressing tool. The members can set a compression pressure and duration of the compression pressure depending on the chosen or desired temperature during the compression and pressing together (and sintering, if applicable).

In some embodiments of the system, the tool can be designed with a number of mold cavities. The mold cavities can extend in parallel relative to each other. Further, the mold cavities can be oriented such that at their first ends, they are arranged opposite a common piston or counterstay member and at their other ends, they are arranged opposite individual counterstay or piston members. The tool can be configured such that at the common piston and/or counterstay member, the tool can have funnel-shaped or cone-shaped portions. In one embodiment, the system can be a substantially fully automated production system, for example, the Procera® type developed by NOBEL BIOCARE.

Through implementation of the embodiments disclosed herein, the implant can be formed to have a color or shade in common with the prosthesis. In particular, the color of upper parts of the implant or those parts which emerge from the hole via the gum can be selectively controlled. In many embodiments, conventional powder compositions can be used for the implant. The pressing together of the different powder types can function extremely well to provide excellent properties, such as strength in the transition layer between different types of powders. If so desired, the implant can be made up of more than two parts, with different or layered powder types in the different parts.

### BRIEF DESCRIPTION OF THE DRAWINGS

The abovementioned and other features of the inventions disclosed herein are described below with reference to the drawings of the preferred embodiments. The illustrated embodiments are intended to illustrate, but not to limit the inventions. The drawings contain the following figures:

FIG. 1 is a side partial cross-sectional view of an implant applied to a jaw bone and gum of a human, and as well as a dental prosthesis connected to the implant, in accordance with an embodiment of the present inventions.

FIG. 2 is a schematic view of a system including a module included in a substantially fully automatic production system, according to another embodiment.

FIG. 3 is a perspective view of a tool for production of the implant illustrated to FIG. 1, according to another embodiment.

FIG. 4 is a side cross-sectional view of the tool of FIG. 3.

FIG. 5 is a side cross-sectional view of the tool of FIG. 3 wherein the tool is being utilized for the formation of a second embodiment of an implant produced by the tool.

FIG. 6 is a side cross-sectional view of a second embodiment of the tool wherein a plurality of implants can be produced simultaneously.

FIG. 7 is a perspective view, obliquely from above, of the tool of FIG. 6.

FIG. 8 is a perspective view of a structural embodiment of the tool.

FIG. 9 is a perspective view of samples produced according to an embodiment of the method.

FIG. 10 is a diagram illustrating, inter alia, an exemplary relationship of the temperature and time in connection with the use of the tool.

### DETAILED DESCRIPTION OF THE PREFERRED EMBODIMENT

According to an embodiment of the present inventions, a dental implant is provided that can be formed to match a color or shade of a dental prosthesis in order to enhance the aesthetic qualities and appearance of the implant and prosthesis. The implant can be formed to include inner and outer parts whose physical and aesthetic properties can be determined utilizing the disclosure and teachings herein. The inner part can be fitted in a hole in the jaw bone and can cooperate substantially with the jaw bone to provide a desired fit. Additionally, the outer part can extend through an upper part of the hole, through the gum and into the oral cavity.

The inner part of the implant can be made completely or partially of compressed powder of biocompatible metal. The inner part is preferably made at least partially of titanium or alloyed titanium. Further, the outer part of the implant can be made completely or partially of compressed powder of biocompatible ceramic. The outer part is preferably made at least partially of zirconium dioxide. The metal and/or ceramic powders can be compressed or pressed together, and can be sintered, to form a body shape of the implant in a single piece.

In some embodiments, particle size or grain size of the powder can be modified. The implant can comprise a plurality of individual parts. These parts can be arranged in layered types of powder and can have transition layers between respective parts.

In this manner, it is contemplated that the implant can be selectively manufactured utilizing a method disclosed and taught herein such that an upper part of the implant, which is adjacent gums of a wearer, is formed to have a desirable appearance. In addition, the compression of different types of powder can also provide excellent strength properties in the transition layer between different types of powders. If so desired, the implant can be made up of more than two parts, with different or layered powder types in the different parts.

It is also noted that embodiments of the implant and the method disclosed herein can be utilized in conjunction with a production principle of the Arcam® type. Further, it is noted that “Rapid Prototyping” with stereolithography (“SLA”) can also be implemented in some embodiments. Additionally, other manufacturing processes which concerns use of powder material in plastic, such as selective laser sintering (“SLS”), can also be used.

In accordance with an aspect of embodiments disclosed herein, metal, for example in the form of titanium or alloyed titanium in powder form, can be combined with ceramic, zirconium dioxide and can be used in the formation of such embodiments of the implant. In the illustrative embodiment, the particle size and grain size of the different powder types can be in the range from merely a few nanometers to approximately 200 nanometers. For example, a grade 4 titanium alloy can be used, cf. ASTM B 346, ASTM F 67, ASTM F 136. In the case of alloyed titanium, it is possible to include in the titanium: approximately between 4 to 8% and preferably, approximately 6% aluminum (Al); and approximately between 2 to 6%, and preferably approximately 4% vanadium (V). The implant or dental product can be formed from combined metal and ceramic materials which cannot be alloyed together. The implant can therefore include different types of material which can be optimized with respect to the tissue and jaw bone in terms of strength, appearance, etc.

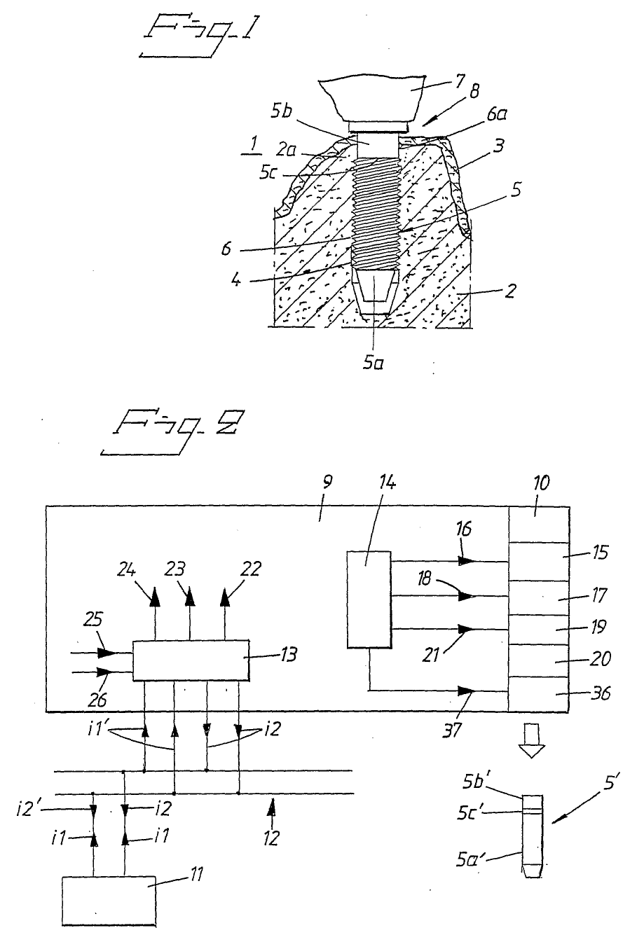

FIG. 1 illustrates a human mouth 1, a jaw bone 2, and the gum 3 of the jaw bone 2. Using known methods and medical procedures, a hole 4 can be formed through the gum 3 and in the jaw bone 2. According to an aspect of embodiments disclosed herein, the hole 4 should be sized and configured to accommodate a dental implant 5, which can facilitate the placement and anchoring of a dental prosthesis.

As illustrated, some embodiments of the implant 5 can be formed to have an external thread 6 by means of which the implant 5 can be screwed into the hole 4 in a known manner. Alternately, other embodiments of the implant 5 can be formed such that the external thread 6 is omitted; in such embodiments, the implant 5 can be driven down into the hole 4 and retained therein by means of a precision fit between the implant 5 and the hole 4.

The partial cross-sectional view of FIG. 1 illustrates that the implant 5 can be made up of an inner part 5a which can be inserted fully into the hole 4. The implant 5 can also have an outer part 5b which can extend from the upper parts 6a of the hole 4 and through the gum 3. At its outer parts 5b, the implant supports a dental prosthesis which can be of various types. The design of the implant 5 and the application of the dental product to the implant 5 can be variously performed. A direction of viewing 8 is also indicated in FIG. 1.

The inner part 5a can be made of metal powder. The metal powder is preferably of a type that has a substantial and well-proven stability function at the same time as a well-proven biocompatibility with respect to the jaw bone. The outer part 5b can be made of ceramic powder. In many embodiments, the outer part 5b can be configured to have a bright shade of color or to be substantially white. Thus, a dark color, typical of metal powder, will not tend to show through from the implant 5 and prosthesis structure in the direction of viewing 8. Upper parts of the implant 5 and the prosthesis can thus merge naturally with the tooth color at the gum 3 and the upper parts 2a at the gum 3. From the aesthetic point of view, this is a considerable advance in dental treatment techniques. In an illustrative embodiment, the implant 5 can include a transition zone 5c which comprises metal powder and ceramic powder in combination.

FIG. 2 illustrates a substantially fully automatic production system 9 of Procera® type. In accordance with an embodiment, a module function 10 can be included for implementing the production method for the implant 5 in the exemplary system 9 shown in FIG. 1. In order to facilitate ordering and delivery of the implant, the system 9 comprises identification and ordering equipment (or orderer) 11 which, via connection 12, can transmit information i1 to the system 9. The connection 12 can transfer the ordering information i1′ to the system 9. Correspondingly, the system 9 can communicate with the orderer 11 by means of information i2 and i2′.

The system 9 can have an internal management and treatment function, and reference may be made here for example to International Publication No. WO 98/44865, entitled “ARRANGEMENT AND SYSTEM FOR PRODUCTION OF DENTAL PRODUCTS AND TRANSMISSION OF INFORMATION.” The system 9 can comprise a unit 14 for controlling and instructing the module 10. As such, the module 10 can comprise identification members 15 which, depending on the information 16 from the unit 14, can determine the shapes and relationships of the inner and outer parts 5a and 5b of the implant 5. The module 10 can also comprise a member 17 which, depending on the powder type and particle and/or grain sizes, can determine the powder quantities for the inner and outer parts 5a and 5b of the implant 5 and can optionally serve to configure the transition layer 5c between the inner and outer parts 5a and 5b. This determination can also be effected from the unit 14 by means of a control 18 in FIG. 2, according to another embodiment.

Application members 19 can also be included in the module 10 for applying the metal and ceramic powders in a pressing tool which can operate with the vacuum cavity and is described in more detail below. The application members 19 can cooperate with or comprise members for setting the compression pressure and duration of the compression pressure as a function of the chosen temperature which is to be present during the compression and pressing together. The application member(s) 19, 20 can be controlled with control information 21 from the unit 14. By means of the module 10, the system 9 can produce other embodiments of the implant, such as the implant 5′ with inner part 5a′, outer part 5b′ and transition layer or transition zone 5c′, as shown in FIG. 2. Furthermore, the module 10 can also include a machining function, such as machining member 36, which is described in greater detail below.

Furthermore, in accordance with an aspect of some embodiments, the implant 5′ can be sent in a known manner, for example by post or parcel delivery, to the orderer or orderer function 1. The order can be made over the public communications 12, for example via the public telecommunications network, computer networks (Internet), etc. The system 9 can be configured to use different internal signals that are symbolized by 22, 23, 24, 25 and 26 in order to carry out various functions.

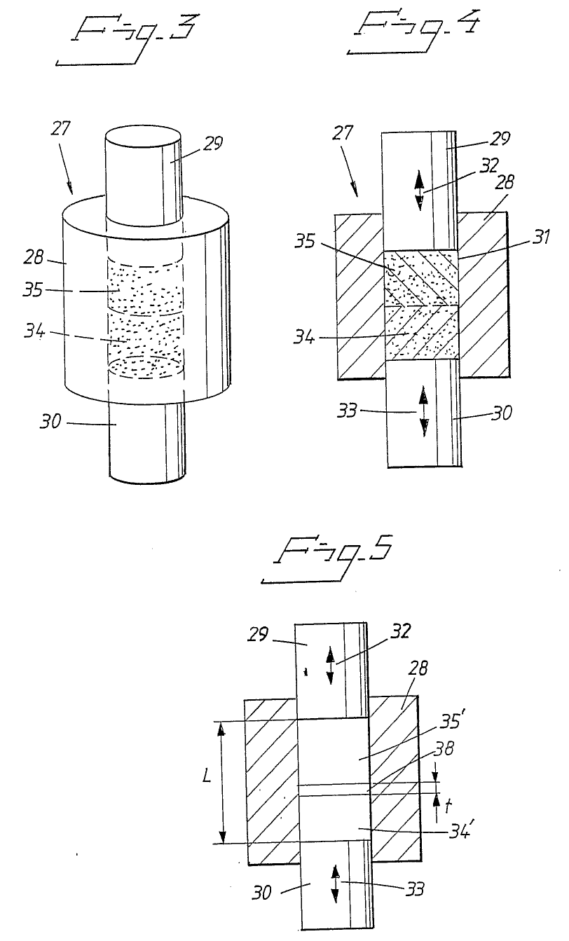

FIGS. 3 and 4 illustrate an embodiment of a pressing tool 27 that can operate with a vacuum cavity. The pressing tool 27 can be made up of components 28, 29 and 30, which are preferably made of graphite. In one implementation, the component 28 can include a cylindrical unit which has a through-hole. For example, the through-hole of the component 28 can be configured as a central hole 31 or cavity (vacuum cavity) in which pistons or counterstays 29, 30 can operate.

In addition, the piston parts 29 and 30 can function as two pistons which can move toward and away from one another in the directions indicated by the double arrows 32 and 33. For example, in order to place powder(s) in the cavity 31, the piston part 29 can be removed so that the powder(s) can be inserted into the cavity 31. In some embodiments, zirconium dioxide powder 34 can be introduced, followed by titanium powder 35, or vice-versa. After inserting the powder(s), the piston part 29 can be repositioned in the cavity 31.

Thereafter, the piston parts 29 and 30 can be moved toward one another to compress the powder(s), and energy can thereby be transmitted to the powders, by which the arrangement can provide a vacuum function in the cavity 31. The inner walls or the inner wall of the cavity 31 can be smooth so that the powders thus pressed together can be removed from the cavity 31 via either one of the piston parts 29 and 30. The cavity 31 can be configured to have a rod shape that corresponds to the outer shape of the implant 5 (see FIGS. 1 and 2). The rod-shaped unit (or implant 5) which is the result of the pressing under vacuum can then be subjected to machining through the machining member 36, shown in exemplary system 9 of FIG. 2. The machining member 36 can serve to modify the rod-shaped unit such that it is formed to include, inter alia, the external thread 6. Alternately, the function can be effected otherwise in the system 9. This function can also be controlled, and the control information for the machining unit 36 has been indicated by 37 in FIG. 2.

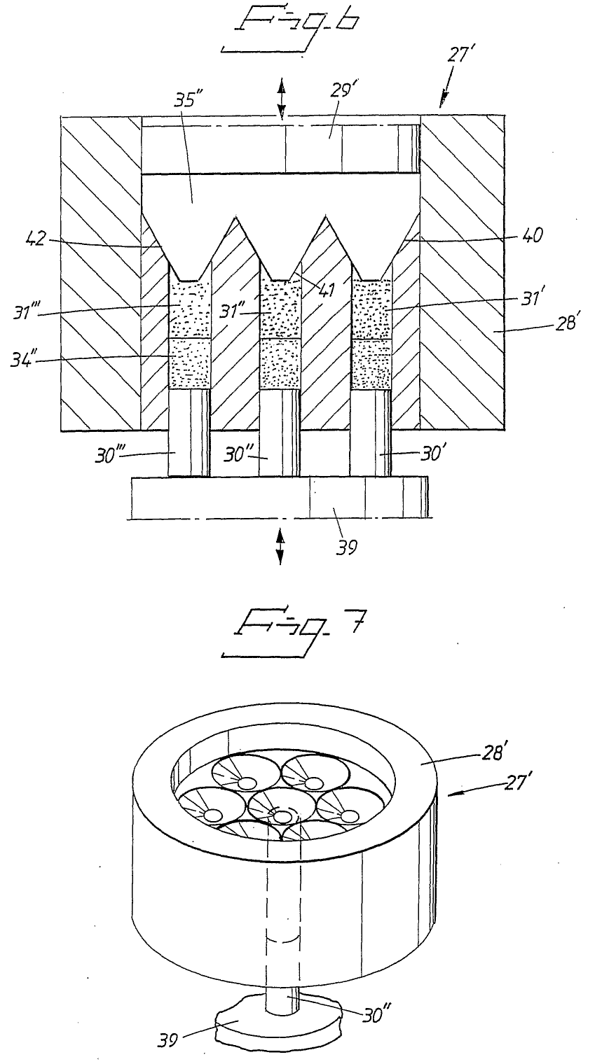

FIG. 5 shows an embodiment of a production method for the rod-shaped unit using titanium powder 35′ and zirconium dioxide powder 34′. In this embodiment, the above-mentioned layer 38 can be obtained in which the zirconium dioxide powder 34′ and the titanium powder 35′ have been mixed. This layer 38 can be given a thickness t, which can be approximately 1 to 3% of a total length L of the finished pressed rod.

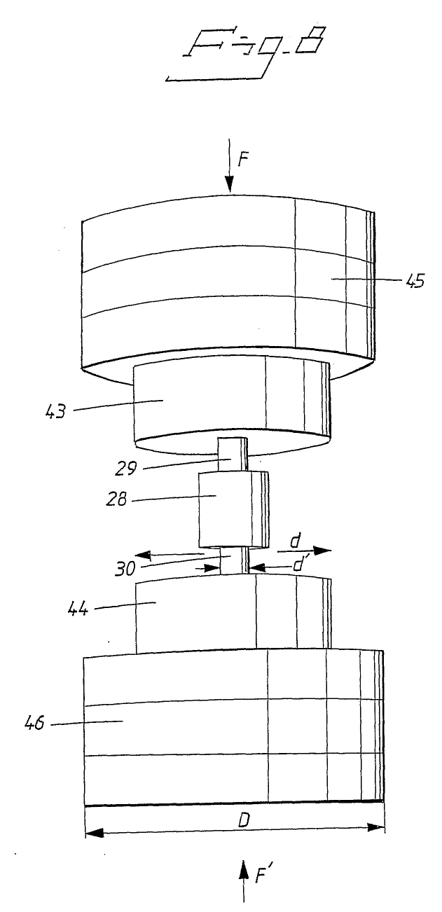

FIGS. 6 and 7 show a second embodiment of a pressing tool 27′ which effects the compression and pressing together of metal and ceramic powders to form a rod-shaped unit for making the implant. In particular, this embodiment can facilitate the joint production of a plurality of rod-shaped elements which can constitute the base of the implant.

In the illustrative embodiment in FIG. 6, the tool 27′ can be configure to include three cavities 31′, 31″ and 31″′, which can be arranged in parallel. In this embodiment, a common piston 29′ can be used to provide compressive force from above for all of the cavities 31′, 31″ and 31″′. Additionally, the tool 27′ can also have individual pistons 30′, 30″ and 30″′ to provide compressive force from below for the respective ones of the cavities 31′, 31″ and 31″′. The tool 27′ can be configured such that the individual pistons 30′, 30″ and 30″′ can be actuated jointly by a common piston 39.

At their upper parts, said cavities 31′, 31″ and 31″′ can be formed to define funnel-shaped portions or extents 40, 41 and 42. In the present embodiment, zirconium dioxide 34″ can be applied in the cavities 31′, 31″, 31″′, after which titanium powder 35″ or alloyed titanium powder can be applied in the cavities 31′, 31″ and 31″′ and in the funnel-shaped parts 40, 41 and 42. In this way, an actuating force on the piston 29′ can be increased in the cavities 31′, 31″ and 31″′ such that sufficient energy is obtained during the compression and pressing together in the cavities.

FIG. 7 is a perspective view of the tool 27′ illustrated in FIG. 6 and shows how seven parallel cavities with funnel-shaped extents 40, 41 and 42 can be arranged in a cylindrical part 28′ of the tool 27′. In this case, only one individual piston 31″ is shown together with the symbolically indicated piston 39; however, it should be noted that as described above, each of the cavities can interact with respective pistons that can be cooperatively actuated by a common piston. It is also contemplated that the extent and number of the cavities can of varied as desired.

FIG. 8 shows a practical and structural illustrative embodiment of the whole construction of the tool. The tool should be configured to provide sufficient energy for the compression and pressing together of the metal and ceramic powders in the cavity(ies). In this exemplary embodiment, the pistons 29 and 30 are arranged in the cylinder 28. These pistons are acted upon respectively via first actuating members 43, 44 which have a diameter d well in excess of a diameter d′ of the respective piston 29, 30. The actuating parts 43, 44 can be respectively acted upon by actuating parts 45 and 46 with diameters D which are well in excess of the diameters d for the parts 43 and 44. In this way, an amount of energy obtained from actuating forces F and F′ on the units 45 and 46 can be selectively substantially increased during the actuation of the pistons 29 and 30. The amounts of energy thus increased can result in the required compression and pressing pressure under which the metal powders form a rod-shaped integral unit.

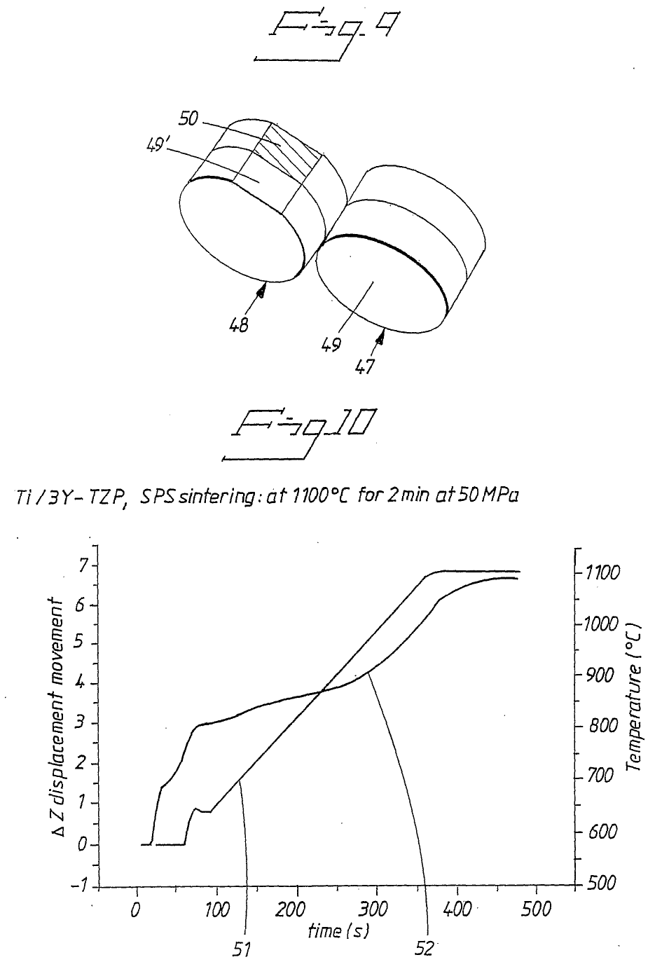

FIG. 9 is intended to show two examples of pressing together or compression to a common unit in accordance with another embodiment. The samples have been designated by 47 and 48. The ceramic powder of the samples 47, 48 has been indicated respectively by 49 and 49′ and the titanium powder of sample 48 has been indicated by 50. The sample 48 has been partially surface-treated, the lighter or white coloring 49′ for the ceramic powder being shown, and also the darker coloring for the titanium powder 50.

FIG. 10 is a graphic representation of how a temperature of 1100° C. is obtained for the above-described sintering, compression or pressing together of ceramic powder and titanium powder Ti/3Y-TZP, SPS. The sintering can, for example, take place for two minutes at a pressure of approximately 50 mPa after the temperature of approximately 1100° C. has been reached. In FIG. 10, reference number 51 shows the temperature of approximately 1100° C. can be reached after approximately 300 to 400 seconds by means of the above-described method and tool. A pressure of approximately 40 to 60 mPa, and preferably approximately 50 mPa, can be used for between 1 and 3 minutes, preferably 2 minutes. The right-hand vertical axis in the diagram shows the number of degrees and the horizontal axis shows the time in seconds. The left-hand vertical axis shows the movements of the powder particles in the ceramic powder, the displacements having been indicated in ΔZ. Said displacements as a function of time have been indicated by the curve 52. In connection with the sintering or compression function, the pressure can be indicated in addition to the indication of the temperature during compression. This can be symbolized by the unit 36 and the control function 37.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

1-15. (canceled)

16. A dental implant for implantation into a hole of a jaw bone, the implant comprising:
a body comprising a first portion and a second portion, the first portion at least partially comprising compressed biocompatible metal powder and the second portion at least partially comprising compressed biocompatible ceramic powder.

17. The dental implant of claim 16, wherein the first portion of the implant is configured to be inserted into the hole of the jaw bone and the second portion is configured to support a dental prosthesis.

18. The dental implant of claim 16, wherein the first portion of the dental implant comprises a distal end of the dental implant that is configured to be inserted into the hole of the jaw bone and the second portion of the implant comprises a proximal end of the implant that is configured to support a dental prosthesis.

19. The implant of claim 16, wherein the compressed biocompatible metal powder is selected from the group consisting of titanium and alloyed titanium.

20. The implant of claim 16, wherein the compressed biocompatible ceramic powder is zirconium dioxide.

21. The implant of claim 16, wherein the compressed powder of the inner part is sintered.

22. The implant of claim 16, wherein the compressed powder of the outer part is sintered.

23. The implant of claim 16, wherein the second portion is sized and configured to extend from the hole in the jaw bone and through gums into the oral cavity.

24. The implant of claim 16, wherein the compressed biocompatible ceramic powder compressed together with the compressed biocompatible metal powder has a light color.

25. The implant of claim 16, wherein the compressed biocompatible ceramic powder compressed together with the compressed biocompatible metal powder is substantially white.

26. The implant of claim 16, wherein the compressed biocompatible metal powder comprises particles with a maximum particle size of approximately 200 nanometers.

27. The implant of claim 16, wherein the compressed biocompatible metal powder comprises approximately 6% aluminum and approximately 4% vanadium.

28. The implant of claim 16, the implant is comprised of a plurality of layered powders.

29. The implant of claim 28, wherein the plurality of layered powders includes transition layers disposed between the inner and outer parts.

30. A method for producing a dental implant implant, the method comprising:
depositing a first amount of a biocompatible metal powder into a cavity of a compression mold;
depositing a second amount of a biocompatible ceramic powder into the cavity of the compression mold; and
compressing the biocompatible metal and ceramic powders under vacuum to form a body of the dental implant

31. The method of claim 31, wherein the compression of the powders is performed approximately at a temperature of 1100° C., for a period of approximately 2 minutes and at a pressure of approximately 50 mPa.

32. The method of claim 31, wherein the powders are respectively deposited into a plurality of cavities for simultaneous fabrication of implants.

33. A system for producing an implant for implantation into a hole of a jaw bone, the implant comprising a body defining an inner part and an outer part, the inner part being sized and configured to be inserted into the hole of the jaw bone, the outer part being sized and configured to support a dental prosthesis, the system comprising:
a pressing tool having at least one cavity wherein an amount of at least one type of compressible biocompatible powder can be deposited for forming the implant;
identification members being operative to determine configurations of the inner and outer parts of the implant and the relationship of the configuration of the inner part with the configuration of the outer part;
quantity determination members being operative to determine powder quantity requirements for the inner and outer parts in response to at least one of a selected powder type, a selected particle grain size, and a selected transition layer thickness between the inner and outer parts; and
application members for compressing the at least one powder to form the implant, the application members being operative to deposit the at least one powder into the pressing tool according to the determined quantity requirements, the application members further being operative to control a compression pressure and a duration of the compression pressure in response to a selected temperature and a selected pressure necessary to perform the compression of the at least one powder.

34. The system of claim 31, wherein the pressing tool comprises a plurality of mold cavities, the cavities extending parallel with respect to each other, each cavity defining first and second ends, the pressing tool further comprising a common piston and a plurality of counterstay piston members, the common piston being sized and configured to exert pressure at the first ends of each of the cavities, each counterstay piston member being sized and configured to be axially aligned with a respective one of the cavities at the second end thereof for cooperatively providing compressive force to the powder deposited in the cavity.

35. The system of claim 34, wherein the first ends of the cavities of the pressing tool include funnel-shaped portions.

36. The system of claim 33, wherein the system is a substantially fully automatic production system.
